(19) United States
(12) Patent Application Publication
(10) Pub. No.: US 2026/0315943 A1
(43) Pub. Date: Oct. 15, 2026

(54) MODEL VEHICLE DRIFT STABILITY MANAGEMENT SYSTEM

(71) Applicant: Traxxas, L.P., McKinney, TX (US)

(72) Inventors: Wesley R Erhart, McKinney, TX (US); Daryl Gene Spillman, Plano, TX (US); Mark Mains, Plano, TX (US); Kent Poteet, Lucas, TX (US)

(21) Appl. No.: 19/255,500

(22) Filed: Jun. 30, 2025

Related U.S. Application Data
(60) Provisional application No. 63/665,781, filed on Jun. 28, 2024.

(51) Int. Cl. A63H 30/04; A63H 17/395; G05D 1/222; G05D 1/49; G05D 105/60; G05D 111/50

(52) U.S. Cl. CPC A63H 30/04; A63H 17/395; G05D 1/2235; G05D 1/49; G05D 2105/60; G05D 2111/52

(57) ABSTRACT

A remote-control model vehicle system including a drift stability management system is provided, including a transmitter, and a model vehicle. The transmitter includes a steering input producing steering commands and a throttle input producing throttle commands. The model vehicle includes a receiver for receiving the steering commands and the throttle commands, an electronic speed control system for providing power to a model vehicle motor corresponding to the throttle commands, and powered wheels located at a rear of the model vehicle and rotationally coupled to the model vehicle motor. The drift stability management system includes a throttle assist equal to a gain*the previous yaw rate. Wherein when the throttle command is greater than zero, a drift throttle command is equal to the throttle command minus the throttle assist and wherein the drift throttle command is sent to the electronic speed control to provide power to the model vehicle motor.

### RELATED APPLICATIONS

This application claims the benefit of a related U.S. Provisional Application Ser. No. 63/665,781, filed Jun. 28, 2025, entitled “MODEL VEHICLE DRIFT STABILITY MANAGEMENT SYSTEM AND METHOD,” to Wesley R. ERHART et al., the disclosure of which is incorporated by reference herein in its entirety.

### BACKGROUND

The following descriptions and examples are not admitted to be prior art by virtue of their inclusion in this section.

Radio-Controlled or RC model vehicles are a popular hobby for a growing segment of the population. Many RC model vehicle operators enjoy attempting to emulate the actions and driving techniques used on full size vehicles. For example, in the off-road portion of the hobby, four wheel-drive crawlers, accurately detailed in scaled down versions of real full-sized vehicles, are taken through off road trails in contests duplicating many of the challenges and issues faced by drivers in a full-sized trail rallies and races.

One of the more popular techniques originated in Japan relatively recently, drifting. The art of drifting typically involves a rear-wheel drive car driven around a corner. The car slides through the turn with the rear wheels spinning at a rate faster than the vehicle speed. The oversteering that results from the sliding rear wheels causes the driver to counter-steer as the vehicle travels around the corner. This technique involves precise application of throttle and steering to achieve a desired effect. Applying this technique to a small RC model vehicle often requires various vehicle modifications and a great deal of operator skill, oftentimes beyond the ability of an average RC model vehicle operator.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In accordance with one embodiment, a remote-control model vehicle system comprising a drift stability management system is provided. The model vehicle system comprises a transmitter, a model vehicle, an electronic speed control system for providing power to a model vehicle motor corresponding to the throttle commands, and powered wheels located at a rear of the model vehicle and rotationally coupled to the model vehicle motor.

The transmitter comprises a steering input producing steering commands and a throttle input producing throttle commands. The model vehicle comprises a receiver for receiving the steering commands and the throttle commands, an electronic speed control system for providing power to a model vehicle motor corresponding to the throttle commands, and powered wheels located at a rear of the model vehicle and rotationally coupled to the model vehicle motor.

Wherein the drift stability management system comprises a previous yaw rate equal to zero, a gyro system for measuring a model-vehicle yaw rate, and a throttle assist equal to a gain times the previous yaw rate. When the throttle command is greater than zero, a drift throttle command is equal to the throttle command minus the throttle assist and the drift throttle command is sent to the electronic speed control to provide power to the model vehicle motor.

In accordance with another embodiment, a remote-control model vehicle system comprising a drift stability management system is provided. The model vehicle system comprises a transmitter including a steering input producing steering commands, a throttle input producing throttle commands, and a button for implementing a wheel-break pulse. In addition, the model vehicle system comprises a model vehicle including a receiver for receiving the steering commands, the throttle commands, and the wheel-break pulse. In addition, the model vehicle comprises an electronic speed control system for providing power to a model vehicle motor corresponding to the throttle commands, and powered wheels located at a rear of the model vehicle and rotationally coupled to the model vehicle motor.

The drift stability management system comprises a previous yaw rate equal to zero, a gyro system for measuring a model vehicle yaw rate, and a throttle assist equal to a gain times the previous yaw rate. When the throttle command is greater than zero, the drift throttle command is equal to the throttle command minus the throttle assist. Wherein the drift throttle command is sent to the electronic speed control to provide power to the model vehicle motor and pressing the wheel-break button sends a breaking pulse to the powered wheels.

In accordance with still another embodiment of this disclosure, a drift-stability management system is provided. The drift-stability management system comprises a previous yaw rate equal to zero, a gyro system for measuring a model vehicle yaw rate, and a throttle assist equal to a gain*the previous yaw rate. When the throttle command is greater than zero, the drift throttle command is equal to the throttle command minus the throttle assist. Further, the drift throttle command is sent to the remote-control model vehicle's electronic speed control to provide power to the remote-control model vehicle's model vehicle motor.

Other or alternative features will become apparent from the following description, from the drawings, and from the claims.

### BRIEF DESCRIPTION OF THE DRAWINGS

Certain embodiments will hereafter be described with reference to the accompanying drawings, wherein like reference numerals denote like elements. It should be understood, however, that the accompanying drawings illustrate only the various implementations described herein and are not meant to limit the scope of various technologies described herein. The drawings are as follows:

FIG. 1 is an elevated schematic view of an RC model vehicle drift stability management system showing a transmitter and a cutaway view of a body on a model vehicle chassis, in accordance to an embodiment of the current disclosure;

FIG. 2 is an elevated schematic view of the representative RC model vehicle body on a model vehicle chassis of FIG. 1 as an operator navigates a corner while drifting, in accordance with an embodiment of the current disclosure;

FIG. 3 shows two Bode plots representing the throttle assist frequency response for a drift stability management system, in accordance with an embodiment of the current disclosure; and

FIG. 4 shows a graph representing the throttle assist step response for a drift stability management system, in accordance with an embodiment of the current disclosure.

### DETAILED DESCRIPTION

In the following specification, numerous specific details are set forth to provide a thorough understanding of embodiments of the present disclosure. However, those skilled in the art will appreciate that the embodiments may be practiced without such specific details. In other instances, well-known elements have been illustrated in schematic or block diagram form in order not to obscure embodiments of the present disclosure in unnecessary detail.

Reference throughout the specification to “one embodiment,” “an embodiment,” “some embodiments,” “one aspect,” “an aspect,” or “some aspects” means that a particular feature, structure, method, or characteristic described in connection with the embodiment or aspect is included in at least one embodiment of the present disclosure. Thus, the appearance of the phrases “in one embodiment” or “in an embodiment” or “in some embodiments” in various places throughout the specification are not necessarily all referring to the same embodiment. Furthermore, the particular features, structures, methods, or characteristics may be combined in any suitable manner in one or more embodiments. The words “including” and “having” shall have the same meaning as the word “comprising.”

Moreover, inventive aspects lie in less than all features of a single disclosed embodiment. Thus, the claims following the Detailed Description are hereby expressly incorporated into this Detailed Description, with each claim standing on its own as a separate embodiment.

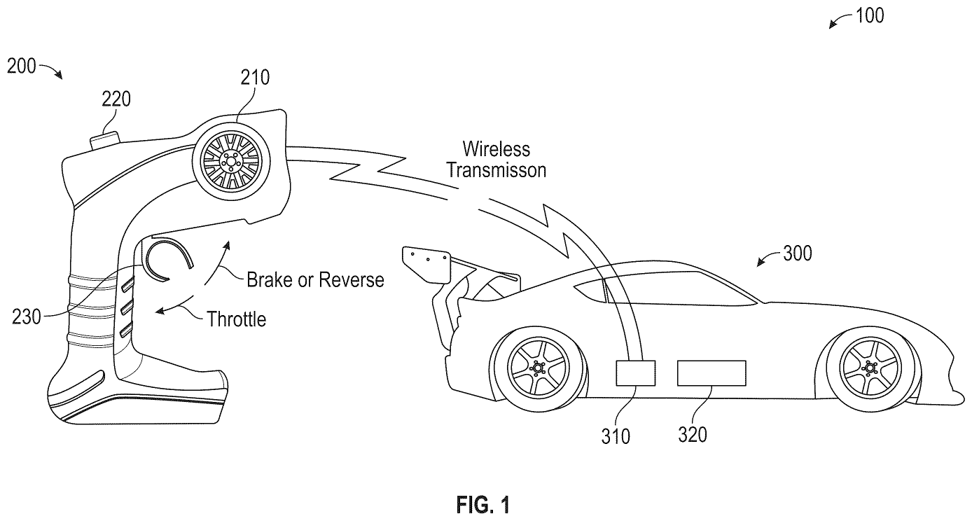

Referring generally to FIG. 1, Radio Controlled (RC) model vehicle systems 100 usually comprise a transmitter 200 and a model vehicle 300. The model vehicle 300 is composed of a model vehicle body coupled to a model vehicle chassis. In some cases, the model vehicle body is a scaled-down version of a full-size vehicle body. And while an automobile is shown in the illustrative embodiment, because these are the full-sized vehicles typically used for drifting, the contents of this disclosure are in no way dependent upon requiring the use of an automobile body. A race car, off road vehicle, rally vehicle, truck, or other vehicle may make use of an embodiment of a drift SMS.

The model vehicle chassis contains the electronics, batteries, and servos required for operating an RC model vehicle 300. In the illustrative embodiment show, the receiver 310 and the electronic speed control (ESC) system 320 are provided within the model vehicle 300. Typically, the model vehicle body encloses and protects the various electronic components mounted within or on the model vehicle chassis. The use of these advanced electronics has led to ease of operation and increased levels of realism for the RC transmitter 200 operator.

Due to the many differences between an RC model vehicle 300 and a full-sized vehicle, duplicating the abilities of a driver by an operator using an RC model vehicle system 100 is difficult. Scale RC model vehicles 300 may react more quickly and more severely to things such as road imperfections and steering inputs than their full-sized counterparts. The speed of the model vehicle 300 and the severity of the reaction to various obstacles challenge the reaction time of an operator.

Stability generalized management systems (SMS) controlled by simple gyro-stabilization may be provided in an embodiment to help inexperienced operators control their RC model vehicle 300. Specifically, a generalized stability management system (SMS), such as Traxxas Stability Management (TSM), may be provided in an RC model vehicle system to aid the model vehicle operator in learning how to realistically and smoothly operate the RC model vehicle 300.

SMSs such as TSM typically include steering stability as taught in U.S. Pat. Nos. 9,975,056 B2 and 10,073,448 B2, co-owned by applicants, the contents of both are herein incorporated in their entirety. TSM steering stability may control the yaw rate of an RC model vehicle to a set point determined by the operator's steering input and (optionally) the speed of the RC model vehicle.

Multi-gyro-stabilization may be possible through the use of Micro-Electro-Mechanical-Systems (MEMS) measuring the angular rotational rates and orientation of the RC model vehicle. The MEMS may measure at least an angular rotation rate about a z-axis of the RC model vehicle 300, in other words, yaw rate. In some scenarios, the gyros may receive the model vehicle operator's steering command and add negative feedback to drive the yaw rate to zero, to control oversteer or understeer.

Drifting is a driving style in which the driver uses the throttle, brakes, clutch, gear shifting and steering input to keep a full-sized vehicle in a state of constant oversteer while driving from turn to turn. Drivers may emphasize car control by coordinating the amount of counter steer (or opposite lock), with the simultaneous modulation of the throttle and brakes to shift the weight balance of the car back and forth through the turns.

However, RC model vehicle operators typically do not have such precise control of a clutch (if present) or the ability to easily change gears to aid in their ability to drift a small-scale RC model vehicle. Drift stability management systems (SMS)(100)(See FIG. 1) may provide an electronic assist to help an RC model vehicle operator duplicate a drifting technique at an early stage of the typical learning curve.

Referring to the exemplary embodiment in FIG. 1, an RC model vehicle system comprising a drift SMS 100 will include a transmitter 200 and an RC model vehicle 300. The transmitter 200 may include a steering input 210 and a throttle input 230. The throttle input 230 is often operated through the use of a trigger as shown in this illustrative embodiment, but other mechanisms such as joysticks, radial dials, and touch screen controls as via a smartphone, may also be used depending upon applicability.

A typical electronic RC model vehicle 200 doesn't have a traditional clutch, brake, and throttle, as found in a full-sized vehicle. Pulling the trigger 230 from a neutral resting point towards the operator produces a forward throttle command for the RC model vehicle 300. Depending upon whether or not the RC model vehicle 300 is moving, pushing the trigger 230 from neutral away from the operator, provides either a braking command (if the model vehicle 300 is moving) or a reverse throttle command (if the model vehicle 300 is determined to be stationary).

The commands produced by the various inputs of the transmitter 200, are wirelessly communicated with the RC model vehicle 300 via a receiver 310. Once a steering command and a throttle command are received by the receiver 310, a corresponding message is communicated with an electronic speed control (ESC) 320. In addition, the receiver 310 may also control a steering server steering the front wheels.

The ESC 320 will send an appropriate amount of power from a main battery to an electronic motor corresponding to the throttle command. In some cases, a battery eliminator circuit (BEC) may be separately provided or incorporated into the ESC 320 for powering the servos and other accessories. In still other cases, a separate set of lower voltage batteries may also be provided in the RC model vehicle 300 for the same purpose as the BEC and in addition to the mail battery.

During drifting the driver manipulates steering and throttle to exceed the friction limit of the rear tires (i.e., friction saturation) while still keeping the front tires (i.e., not friction saturated) within their grip threshold. This creates a scenario where the rear tires have high slip angles, and the front tires are counter steered. However, while drifting, a driver still desires to control the vehicle and produce a relatively low vehicle yaw rate.

For RC drifting, an SMS such as TSM may provide relatively better curvature control for new drifters. However, even with SMS, drifting requires the operator to anticipate how the RC model vehicle 300 will react to steering input 210 and throttle input 230 changes.

Accordingly, a determined new drifter with a traditional gyro or even with a generalized SMS, can become discouraged before mastering the nuances of drifting. The new operator must manipulate both steering input 210 and throttle input 230 to control the RC model vehicle 300. The changes affected by manipulating the steering input and throttle input can occur on different time scales and vary based on direction, and in some cases, road conditions. For example, during a drift, “control authority through the front steering input is essentially unidirectional.” The steering input can decrease the yaw rate of the RC model vehicle 300 but cannot necessarily increase yaw rate.

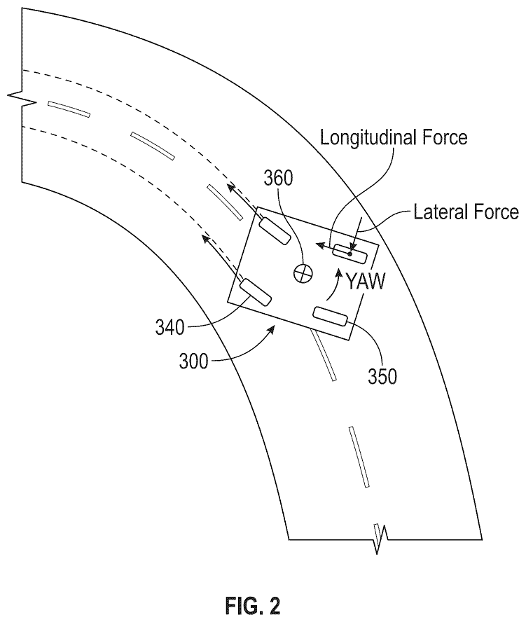

Referring generally to FIG. 2, the technique of drifting requires that the rear wheels 350, specifically, the rear tires, are friction saturated. Additionally, the front wheels 340 remain non-friction saturated. Friction saturation is when the combined lateral and longitudinal force demand on the rear wheels 350 exceeds the available friction force. When the rear wheel is spinning relative to the ground, i.e., each rotation of the rear wheel results in a significantly shorter distance travel than the distance corresponding generally to the circumference of the wheel, the wheel is friction saturated.

Increasing the rear wheel spin rate may increase the longitudinal component and decrease the latitudinal component against the demanded friction force. Generally, the decrease in the lateral component in a yawing vehicle causes the yawing model vehicle 300 to increase its yaw rate around the center of mass 360. The front wheels 340 are not friction saturated and therefore allow the operator to steer the model vehicle 300 around the corner.

For example, if a model vehicle 300 is going around a corner, the model vehicle 300 has momentum. The rear wheels 350 are acted upon by a centrifugal force due to traveling around the corner and a forward force due to the friction between the rear wheels 350 and the road. Accordingly, non-saturated rear wheels 350 will have an increased friction force providing a forward force and a centripetal force allowing the RC model vehicle 300 to proceed around the corner with a relatively low yaw rate.

Increasing the throttle to induce friction saturation will lessen both the forward force (longitudinal force) and the centripetal force (lateral force). As the friction saturated rear wheels spin faster and faster, this lowers the lateral centripetal force against the rear wheels and the yaw rate of the model vehicle will increase as the centrifugal force from the corner acts upon the model vehicle 300 around the center of mass 360 and the non-friction saturated front wheels 340 producing a counterclockwise rotation or yaw in this particular example.

Lowering the friction saturated rear wheel 350 spin rate will increase the centripetal force and reduce the yaw rate caused by the centrifugal force due to the momentum of the model vehicle 300 around the corner. In other words, reducing the rear wheel 350 spin rate diminishes the longitudinal force component and increases the lateral force component against the demanded force. Generally, the increase in the lateral force component in a yawing model vehicle 300 causes the yawing model vehicle 300 to decrease its yaw rate, giving an operator time to react to the conditions of the model vehicle 300.

In one embodiment, a throttle assist exploits half (i.e., lowering the yaw rate) of this mechanic to slow yaw rate increase by temporarily reducing the operator's commanded throttle. Throttle assist executes within the receiver's drift SMS function.

Specifically, the difference between sequential z-axis gryo measurements is taken and this value times a negative gain is added to the operator's throttle. In this particular embodiment, the throttle assist acts as a damper, slowing down the yaw rate and giving the operator time to react as their model vehicle 300 navigates a corner.

This throttle assist function can be modeled as:

x=gyro gz(i.e. yaw rate)
throttle assist=gain*y

y=x−xlast+0.9801986733067554*y last
if (operator throttle command>0) throttle=max (operator throttle command−gain*y, 0)

“x_last” is the previous gyro z-axis measurement. The “throttle” is the amount of throttle sent to the Electronic Speed Control (ESC) for conversion into the amount of battery power sent to the electric motor. The assist amount is “gain*y”. This is subtracted from the “operator” throttle request and lower bound to 0 (i.e., no reverse throttle command will be sent to the ESC).

The gain is fixed but y is determined as a dynamic response to the gyro's z-axis rotation rate. Looking at the dynamics of y. The y continuous time transfer function is:

H(s)=s/(s+2)

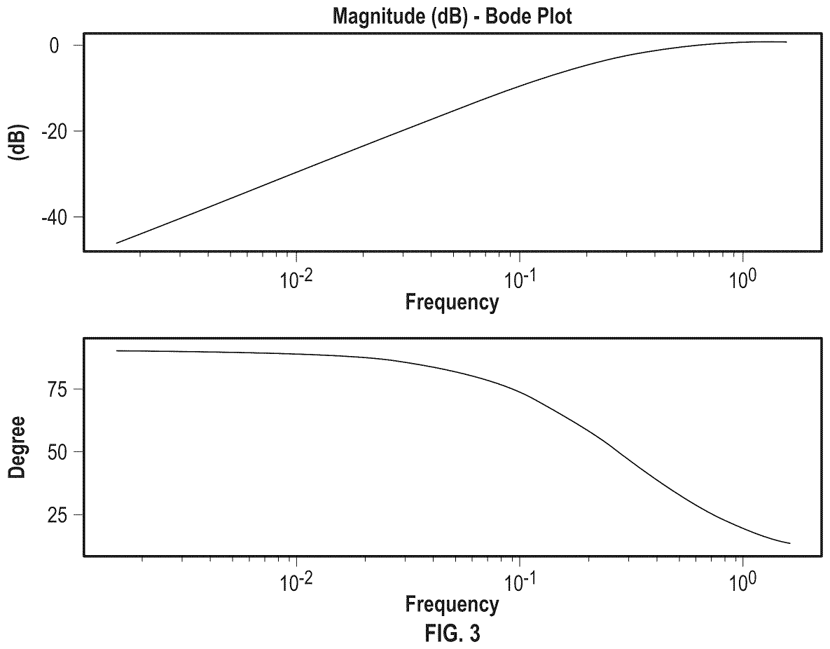

This yields the following frequency response as shown in the Bode Plots in FIG. 3. In the top plot, the y-axis is in decibels (dB), and the x-axis is frequency. In the bottom plot, the y-axis is in degrees, and the x-axis is frequency.

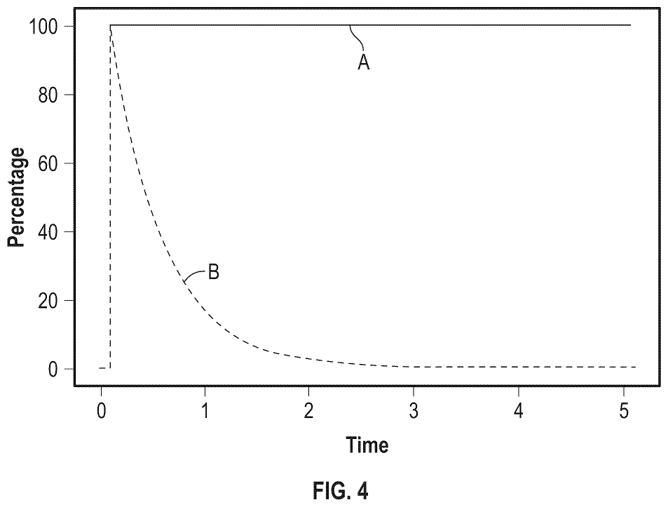

Referring generally to FIG. 4, this graph shows the step response of the throttle assist. The solid line at the top is the operator's throttle input. The broken line underneath the throttle input is the throttle assist. The y-axis is percentage and the x-axis is time. The figure shows a throttle assist step response to a sudden increase in the z-axis yaw rate. The throttle assists proportionally increases but drains away with time giving the driver time to recognize the yaw rate increase and adjust the throttle to compensate.

This is one aspect of drift SMS's drift control for this illustrative embodiment. Throttle assist may be on by default in drift SMS's drift mode. In some cases, throttle assist may be provided as an option.

Overall, this aspect dampens the yaw rate response of the model vehicle to give the operator time to react and respond to the conditions of the model vehicle in real time. For this reason, only reduction in the yaw rate is produced.

Another embodiment of the current disclosure may include throttle control, in addition to throttle assist or independently. Throttle control exploits the mechanic described in the previous section and executes coincidentally with drift SMS's steering stability. Throttle control is active when the steering command is in the opposite direction of the z-axis yaw rate. Throttle control is inactive when the steering command coincides with the yaw rate of the vehicle (i.e., normal, non-drift steering).

When active, throttle control adds (or subtracts) from the operator's throttle command by an amount determined by the difference between the operator's steering commanded yaw rate and the z-axis gyro.

For example, in one embodiment of a proportional (P)-only proportional, Integral, and Derivative (PID) controller, if the operator is commanding a 20°/s yaw rate and the front wheels are counter-steered but the measured z-axis yaw rate is 10°/s, the throttle control function adds an amount proportional to the difference between the commanded rate and the measure rate.

Several aspects of throttle control are determined by operator testing. These aspects include:
1. Gain scheduling where the gain the throttle control value is adjusted based on other measured parameters (e.g. accelerometers) or control parameters (front wheel angle).
2. Adjustments to the into and out of counter-steer switch in of the throttle control.

Throttle control may be operator configurable and altered before and/or after operating the model vehicle.

As noted above, the technique of drifting requires the rear wheels 350 to be friction saturated. To achieve this, the rear wheels and corresponding tires must “break” from the driving surface (i.e., road, racetrack, etc.). To break the rear wheels 350 free from the driving surface, a breaking torque needs to be applied. This breaking torque can be a sudden acceleration of the rear wheels 350 or a sudden deacceleration of the rear wheels 350. Once the rear wheels 350 are sliding relative to the driving surface and are friction saturated, throttle can then be applied to the rear wheels using the throttle input to spin them to an appropriate speed able to produce a balancing of desired longitudinal and lateral forces.

Generally, simultaneous with “breaking” of the rear wheels, the operator introduces a yaw rate by steering into the turn providing the initiation of the drift stability management system steering stability, throttle assist, and throttle control.

Some embodiments may use a wheel-break button to produce the sudden deceleration of the rear wheels 350, a short-term break-pulse. The wheel-break button 220 may repurpose an eBrake switch 220 on the transmitter 200 (see FIG. 1), such as discussed in US Patent Application Ser. Number 2022/0288500 A1, the contents of which are herein incorporated by reference, to send a break-pulse command applying a motor brake for a configurable duration and level.

In one embodiment, the appropriate duration of wheel-breaking is configurable and provided with 3 presets, rough concrete, smooth concrete, polished concrete. The rougher the road surface, the longer the break-pulse command. Drive testing is used to modify the minimum amount of time needed to break the wheels from a surface at a moderate speed for 3 different surfaces. For example, the presets may be rough concrete—1 sec, smooth concrete—0.5 sec, and polished concrete—0.01 sec. In some embodiments, the presets may be experimentally determined values.

In yet another embodiment, a preset value of wheel-breaking may be provided and used when the wheel break button 220 is pressed. The duration of pressing the wheel-break button 220 is independent of duration of the break pulse. In still other embodiments, the duration of the pressing the wheel-break button 220 may be the same as the duration of the break-pulse.

When the operator presses the transmitter's wheel-break function, the receiver interrupts the throttle command and sends a wheel-break command to apply a brake pulse to the motor for the duration of the particular preset, regardless of how long the button has been pressed. Once the duration of the wheel-break command passes, the receiver applies the current throttle command. Although the wheel-break button has been described as using a brake pulse, the same may be true for implementing a throttle pulse, in which case, pressing the wheel-break button may produce a temporary 100% throttle pulse for a preset duration based upon the surface conditions of the road or course surface.

This simplifies the operator's control manipulation as the operator can maintain forward throttle and press the wheel-break button rather than moving the throttle input to the brake position and back to the throttle position, or moving the throttle input rapidly to the full, 100% for the duration of the break-pulse and then back to the current throttle position. As mentioned above, an RC operator's simultaneous manipulation of the steering input 200 and the throttle input 230 is one of the aspects making the technique of drifting challenging for a model vehicle 300. In this case when entering a drift, the operator can focus on steering.

Although only a few example embodiments have been described in detail above, those skilled in the art will readily appreciate that a wide range of variations, modifications, changes, and substitutions are contemplated in the foregoing disclosure and, in some instances, some features of the present disclosure may be employed without a corresponding use of the other features.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A remote-control model vehicle system comprising a drift stability management system comprises:
a transmitter comprising:
a steering input producing steering commands;
a throttle input producing throttle commands;
a model vehicle comprising:
a receiver for receiving the steering commands and the throttle commands;
an electronic speed control system for providing power to a model vehicle motor corresponding to the throttle commands;
powered wheels located at a rear of the model vehicle and rotationally coupled to the model vehicle motor;
wherein the drift stability management system comprises:
a previous yaw rate equal to zero;
a gyro system for measuring a model vehicle yaw rate;
a throttle assist equal to a gain*the previous yaw rate;
wherein when the throttle command is greater than zero, a drift throttle command is equal to the throttle command minus the throttle assist; and
wherein the drift throttle command is sent to the electronic speed control to provide power to the model vehicle motor.

2. The remote-control model vehicle system according to claim 1, wherein the drift stability management system further comprises:
a wheel-break button on the transmitter for providing a breaking pulse command to the powered wheels.

3. The remote-control model vehicle system according to claim 1, wherein the gain is equal to 0.98.

4. The remote-control model vehicle system according to claim 1, wherein the gain is equal to 0.9802.

5. The remote-control model vehicle system according to claim 1, wherein the gain is equal to 0.9801986733067554.

6. The remote-control model vehicle according to claim 2, wherein the wheel-brake button uses one of three preset breaking pulses selected by an operator depending upon road conditions.

7. The remote-control model vehicle according to claim 6, wherein the three preset breaking pulses correspond to rough, smooth, and polished road surfaces.

8. The remote-control model vehicle according to claim 7, wherein the three preset breaking pulses are adjustable based on model vehicle reactions.

9. The remote-control model vehicle according to claim 2 wherein the breaking pulse is a brake pulse.

10. The remote-control model vehicle according to claim 2 wherein the breaking pulse is a throttle pulse.

11. A remote-control model vehicle system comprising a drift stability management system comprises:
a transmitter comprising:
a steering input producing steering commands;
a throttle input producing throttle commands;
a button for implementing a wheel-break pulse;
a model vehicle comprising:
a receiver for receiving the steering commands, the throttle commands, and the wheel-break pulse;
an electronic speed control system for providing power to a model vehicle motor corresponding to the throttle commands;
powered wheels located at a rear of the model vehicle and rotationally coupled to the model vehicle motor;
wherein the drift stability management system comprising:
a previous yaw rate equal to zero;
a gyro system for measuring a model vehicle yaw rate;
a throttle assist equal to a gain*the previous yaw rate;
wherein when the throttle command is greater than zero, drift throttle command is equal to the throttle command minus the throttle assist;
wherein the drift throttle command is sent to the electronic speed control to provide power to the model vehicle motor; and
wherein pressing the wheel-break button sends a breaking pulse to the powered wheels.

12. The model vehicle system according to claim 11, wherein the breaking pulse is a brake-pulse.

13. The model vehicle system according to claim 11, wherein the breaking pulse is a throttle-pulse.

14. The model vehicle system according to claim 11, wherein the gain is 0.9802.

15. A drift stability management system configured to control a remote-control model vehicle and comprising:
a previous yaw rate equal to zero;
a receiver for receiving a throttle command and a steering command;
a gyro system for measuring a model vehicle yaw rate;
a throttle assist equal to a gain*the previous yaw rate;
wherein when the throttle command is greater than zero, a drift throttle command is equal to the throttle command minus the throttle assist; and
wherein the drift throttle command is sent to the remote-control model vehicle's electronic speed control to provide power to the remote-control model vehicle's model vehicle motor.

16. The drift stability management system according to claim 15, wherein the receiver further receives a break-command for sending a break pulse to the model vehicle motor.

17. The drift stability management system according to claim 16, wherein the break pulse is a brake pulse.

18. The drift stability management system according to claim 16, wherein the break pulse is a throttle pulse.

19. The drift stability management system according to claim 15, wherein the gyro system comprises an electronic gryo for measuring rotation around a z-axis.

20. The drift stability management system according to claim 16, wherein the break-command is one of 3 presets selected by an operator in response to course surface conditions.
